(19) United States
(12) Patent Application Publication
(10) Pub. No.: US 2025/0377883 A1
(43) Pub. Date: Dec. 11, 2025

(54) METHODS AND SYSTEMS FOR UPDATING DEVICE FIRMWARE USING A BOOTLOADER TRAP IN IMMUTABLE STORAGE MEMORY

(71) Applicant: SK Hynix NAND Product Solutions Corp. (dba Solidigm), Rancho Cordova, CA (US)

(72) Inventor: Myron Loewen, Berthoud, CO (US)

(21) Appl. No.: 18/740,377

(22) Filed: Jun. 11, 2024

(51) Int. Cl. G06F 8/654; G06F 9/4401

(52) U.S. Cl. CPC G06F 8/654; G06F 9/4401

(57) ABSTRACT

A system and related method for loading firmware on a device including processing circuitry and immutable storage memory, where the processing circuitry causes a device startup to be initiated based on startup code stored in the immutable storage memory. While the device startup is being initiated, the processing circuitry is to receive a first signal and determine that a second signal was not received within a minimum wait time following the receipt of the first signal. Once the processing circuitry has determined that the second signal was not received within the minimum wait time following the receipt of the first signal, the processing circuitry is to load the firmware on the device. A controller may be used when loading firmware on one or more devices of a plurality of devices. The first signal and the second signal may be a first interrupt signal and a second interrupt signal, respectively.

### TECHNICAL FIELD

The present disclosure is related to devices and methods for loading firmware on a device, and more particularly, the present disclosure is related to loading firmware on a device without additional hardware.

### BACKGROUND

Devices (e.g., storage devices) may be connected to a network interface (e.g., a Peripheral Component Interconnect Express (PCIe) interface or Non-Volatile Memory Express (NVMe)). During the operation of the devices, the firmware of one or more devices may require an update or a change, which may cause performance inefficiencies for each device or use additional hardware to facilitate firmware updates. For example, an update or change in firmware may be due to a corrupted or compromised portion of the existing, mutable firmware running on the device. In such an example, the corrupted or compromised existing firmware cannot be used to update itself with an uncompromised image of the existing firmware or a new firmware.

### SUMMARY

In accordance with the present disclosure, devices and methods are provided for loading firmware on a device, such as on a solid-state drive (SSD) device, by trapping the device while performing device startup code stored in a secure and trusted portion of immutable storage memory (e.g., Read-Only Memory (ROM), one or more one-time programmable fuses, a protected electrically erasable programmable read-only memory (EEPROM), or a write-once-read-many (WORM) storage memory). For example, an SSD device that has immutable storage memory securely storing startup code, and processing circuitry to execute operations using an existing firmware receives a startup signal to initiate a device startup based on startup code stored in the immutable storage memory. If the device receives, at the processing circuitry, a first signal and then during a minimum wait time after receiving the first signal receives the firmware (e.g., a firmware image) and does not receive a second signal, the processing circuitry loads firmware (e.g., updated firmware, a firmware image of the existing firmware) on the device. Once the firmware is loaded onto the device, the processing circuitry may execute operations or instructions using the firmware. This bootloader trap firmware update method may be implemented at least in part on the processing circuitry using software, hardware, or a combination thereof. In some embodiments, the bootloader trap firmware update method is used after the device (e.g., an SSD device) has been manipulated or the data stored in memory (e.g., persistent storage media of the device) has been corrupted. When data or instructions stored in the device are corrupted or manipulated, it may be difficult to ensure that the loading of firmware is performed securely and safely. The bootloader trap firmware update method may also be used to recover firmware from unintentional errors or faults, security breaches or failed memory blocks or memory cells.

In some embodiments, to perform the bootloader trap firmware update, the device causes a device startup to be initiated and receives a first signal to pause the device startup and trap the bootloader while it is executing from the immutable storage memory. The first signal may be any suitable signal that is transmitted by an external device (e.g., a controller). The first signal may be a signal that is used for another purpose (e.g., an interrupt signal). Although the processing circuitry of the device is able to differentiate each use case of the signal, i.e., when the signal is being used to trap the bootloader for purposes described herein or when the signal is being used for this other purpose. For example, when the first signal is an interrupt signal, the first signal may be a first of at least two interrupt signals that are transmitted to the device to indicate data or instructions that are to be processed by the processing circuitry. However, the processing circuitry of the device may be configured such that when an interrupt signal is received as the first signal, and no second signal (e.g., a second interrupt signal) is received within a minimum wait time after the receipt of the first signal, the processing circuitry may then proceed to load the firmware.

In some embodiments, the bootloader trap firmware update can be used to update or change firmware of any suitable device having processing circuity communicatively coupled to an interface (e.g., PCIe interface or NVMe interface) from which to receive data or instructions. In some embodiments, the device may, for example, be any suitable storage device that may communicate over the PCIe interface by using a NVMe standard protocol. The NVMe industry standard protocol defines a register level interface for a host device (e.g., the controller) to communicate with the device (e.g., SSD or HDD) over the PCIe interface. The bootloader trap firmware update may be used to update firmware of any suitable device having processing circuitry that has one or more processors, wherein each processor may have one or multiple cores.

In some embodiments, when loading the firmware, the processing circuitry may maintain data associated with the operating state of the existing firmware. In some embodiments, the data associated with the operating state of the existing firmware include a firmware version of the existing firmware, a firmware signature of the existing firmware, outstanding transactions to be executed, a state of the existing firmware, and an input/output connectivity state of the existing firmware, each of which can maintained from the existing firmware to after the firmware is loaded by processing circuitry. In some embodiments, when at least a portion of memory or data associated with the operating state of the existing firmware is corrupted, this data associated with the operating state of the existing firmware may be discarded to not further propagate unexpected errors or performance issues for the device. In some embodiments, when no existing firmware is present or the firmware signature of the existing firmware fails (e.g., due to corruption or manipulation), the bootloader of the processing circuitry, while executing from the immutable storage memory, will wait until the new firmware is loaded before completing the device startup.

### BRIEF DESCRIPTION OF THE DRAWINGS

The following description includes discussion of figures having illustrations given by way of examples of implementations of embodiments of the invention. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows an illustrative diagram of a system with a device and a controller, in accordance with some embodiments of the present disclosure;

FIG. 2 shows an illustrative diagram of another system with multiple devices and a controller, in accordance with some embodiments of the present disclosure;

FIG. 3 shows a flowchart illustrating a process for loading firmware on a device, in accordance with some embodiments of the present disclosure;

FIG. 4 shows a flowchart illustrating a process for loading firmware on one or more devices using a controller, in accordance with some embodiments of the present disclosure; and

FIG. 5 shows a diagram illustrating chronological flow between a controller and processing circuitry of a device that concurrently execute programs or routines, in accordance with some embodiments of the present disclosure.

### DETAILED DESCRIPTION

In accordance with the present disclosure, systems and methods are provided for performing a bootloader trap firmware update on a device (e.g., a PCIe device or NVMe device). The features of the present disclosure related to updating or changing firmware on a device are applicable to devices having immutable storage memory and processing circuitry with multiple processors, one or more multi-core processors, or both. For example, in some embodiments, the device is an SSD device that has an immutable storage memory (e.g., ROM, protected EEPROM or any suitable WORM) and processing circuitry. A multi-core processor that may be included in processing circuitry allows for multiple instructions to execute concurrently by using multiple cores. It will be understood that while the present disclosure is described primarily in the context of devices with processing circuitry having a multi-core processor, the features of the present disclosure can be similarly applied to distinct processors (whether uni-core, multi-core, or both).

In some embodiments, the firmware of the processing circuitry of this example device may need to be updated. For example, the firmware of the device may be outdated or corrupted. Firmware of processing circuitry may include a set of instructions or microcode needed to define the functionality of the processing circuitry. Firmware is loaded on a device as microcode that may be stored in a reserved region of local memory that is accessible to the processing circuitry. In some examples, the firmware may be received from an external device (e.g., a controller communicatively coupled to the device). When the firmware of the device is compromised (e.g., corrupted or outdated), a bootloader trap firmware update may be used by processing circuitry to ensure a more efficient and secure change or update in firmware of one or more devices running with compromised firmware.

In some embodiments, processing circuitry of the device initiates a device startup based on the receipt of a startup signal from the controller. During the device startup, the processing circuitry may receive a first signal from the controller. The first signal may be an interrupt signal, or any suitable signal received over an interface (e.g., PCIe interface or NVMe interface) from the controller. Once the processing circuitry receives the first signal, the processing circuitry may pause the device startup. During the minimum wait time after the receipt of the first signal, the processing circuitry is configured to receive firmware (e.g., a firmware image of firmware previously loaded on the device or an updated firmware). In some embodiments, the processing circuitry receives the firmware from a controller communicatively coupled to the device. When the processing circuitry determines that the device did not receive the second signal during the minimum wait time after the receipt of the first signal, processing circuitry may determine that the first signal is being used to trap the bootloader. At this stage, the bootloader of the processing circuitry is initiating or executing the device startup from the immutable storage memory of the device. Trapping the bootloader of the processing circuitry at this stage ensures a more secure and efficient update or change in the firmware of the device. The processing circuitry then loads the received firmware on the device, e.g., by updating or changing the existing firmware of the device. Once the processing circuitry loads the firmware on the device, the processing circuitry may transmit a confirmation signal to the controller indicating that the firmware has been successfully loaded on the device by the processing circuitry. Finally, the bootloader trap firmware update completes, and the processing circuitry continues to complete the device startup to then execute transactions using the new firmware.

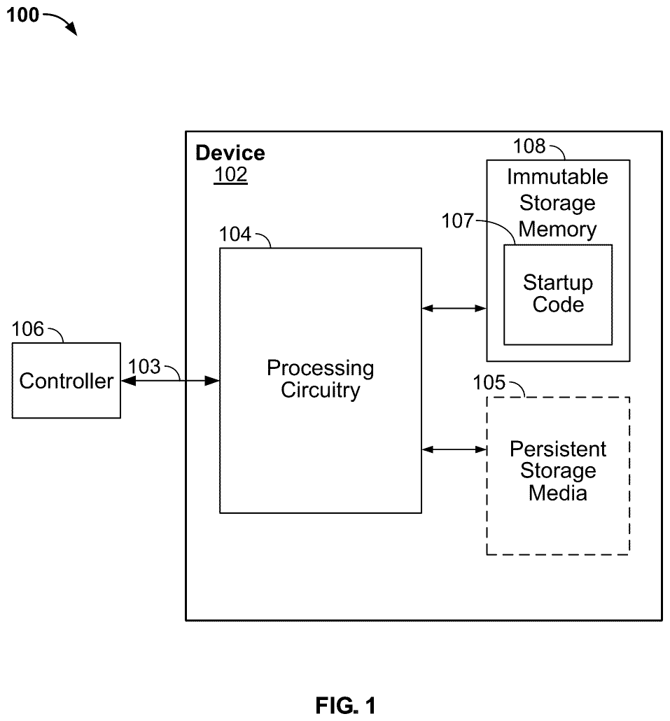

The subject matter of this disclosure may be better understood by reference to FIGS. 1-5.

FIG. 1 shows an illustrative diagram of a system 100 with a device 102 and controller 106 which are communicatively coupled to each other by an interface 103 (e.g., a PCIe interface or NVMe interface), in accordance with some embodiments of the present disclosure. Device 102 includes processing circuitry 104 and immutable storage memory 108 that is used to store startup code 107. In some embodiments, device 102 is a storage device (e.g., a solid-state drive (SSD) device) and includes persistent storage media 105. It will be understood that the embodiments of the present disclosure are not limited to SSDs. For example, in some embodiments, system 100 may include a hard disk drive (HDD) device in addition to or in place of device 102.

An SSD device, such as device 102 in some implementations, is a data storage device that uses integrated circuit assemblies as memory to store data persistently. SSD devices have no moving mechanical components, and this distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency.

Many types of SSDs use NAND-based flash memory which retains data without power and include a type of non-volatile storage technology. For example, in some embodiments, the SSD may use a NAND-based flash memory, a NOR-based flash memory, or any other non-volatile memory, or any combination thereof. Quality of Service (QoS) of an SSD may be related to the predictability of low latency and consistency of high input/output operations per second (IOPS) while servicing read/write input/output (I/O) workloads. This means that the latency or the I/O command completion time needs to be within a specified range without having unexpected outliers. Throughput or I/O rate may also need to be tightly regulated without causing sudden drops in performance level.

The processing circuitry 104 is configured to perform operations using an existing firmware that is preloaded onto device 102 or recently updated. There may be a time during the lifetime of device 102 at which the device 102 requires an update or change in firmware. The processing circuitry 104 is configured to access start up code 107 in immutable storage memory 108 in order to initialize or reinitialize device 102 before updating the firmware. In some embodiments, the bootloader of processing circuitry 104 executes the startup code 107 from the immutable storage memory 108. Additionally, device 102 may include persistent storage media 105. In some embodiments, the persistent storage media 105 includes any one or more of a Phase Change Memory (PCM), a PCM and switch (PCMS), a Ferroelectric Random Access Memory (FeRAM), or a Ferroelectric Transistor Random Access Memory (FeTRAM), and a Magnetoresistive Random Access Memory (MRAM), any other suitable memory, or any combination thereof. The processing circuitry 104 and immutable storage memory 108 are communicatively coupled to each other by a data bus. When persistent storage media 105 is included in device 102, processing circuitry 104 is communicatively coupled, via a data bus, to the persistent storage media 105.

Processing circuitry 104 may receive a startup signal from controller 106, where the startup signal indicates to processing circuitry 104 to initiate a device startup based on startup code 107 stored in immutable storage memory 108. In some embodiments, the startup signal may be a reset signal, power cycle signal, or any suitable signal that instructs or indicates to the processing circuitry 104 to perform the device startup. During the device startup, controller 106 may generate and transmit a first signal on interface 103 to be received by processing circuitry 104. In some embodiments, the first signal is an interrupt signal, or any suitable signal received over interface 103 (e.g., PCIe interface or NVMe interface) from the controller 106. Once the processing circuitry 104 receives the first signal, the processing circuitry 104 causes the device startup to be paused, i.e., trapping a bootloader of the processing circuitry while it is executing from the immutable storage memory 108 and performing device startup based on the startup code 107. In some embodiments, the processing circuitry 104 may receive a second signal from the controller 106 within a minimum wait time after the processing circuitry 104 receives the first signal. In some embodiments, the second signal is an interrupt signal, or any suitable signal received over interface 103 (e.g., PCIe interface or NVMe interface) from the controller 106. In some implementations, the first signal and the second signal are each of a same type of signal (e.g., interrupt signal) and from a same source (e.g., the controller 106). For example, the first signal, the second signal, or both are one of a System Management Bus (SMBus) signal (e.g., SMBus interrupt signal) or an Improved Inter-Integrated Circuit (I3C) signal (e.g., I3C interrupt signal). In some embodiments, each of the first signal and the second signal is from a different source. For example, the first signal may be received from the controller 106 and the second signal may be received from an additional external host device (e.g., a second device). In some embodiments, the first signal, the second signal, or both, may be one of the following: (a) a condition on an SMBus interface that persists for a minimum period of time, (b) a PCIe interface signal transmitted on an out-of-band (OOB) interface (e.g., PCIe reset (PERST) signal), (c) one or more traffic SMBus signals on an SMBus interface, (d) a timing interrupt or (e) a combination of (a)-(d) in a predetermined sequence. In some embodiments, the one or more SMBus traffic signals include one or more specific memory address, command type, or payload to indicate to processing circuitry 104 that the SMBus traffic signal acts as one of the first signal or second signal. In such embodiments, receiving the second signal within the minimum wait time after receiving the first signal indicates to the processing circuitry 104 that the firmware of the device is not to be updated or changed. Instead, the processing circuitry is to perform operations based on the first signal, the second signal, and any other data or signals that are received thereon. In some embodiments, the second signal may be an abort signal (e.g., a timeout interrupt). In other embodiments, the minimum wait time elapses after the processing circuitry 104 receives the first signal and the processing circuitry 104 does not receive the second signal during the minimum wait time, and therefore the processing circuitry may determine that the first signal is intended to trap the bootloader of the processing circuitry 104 while initiating or executing the device startup from the immutable storage memory 108 of the device 102. Once this determination is made, the processing circuitry 104 is configured to load the firmware on the device 102. Once the processing circuitry 104 loads the firmware onto the device, i.e., updating or changing the existing firmware of the device 102, a confirmation signal may be transmitted by the processing circuitry 104 and received by controller 106. The confirmation signal may indicate to the controller 106 that the firmware has been successfully loaded on the device by processing circuitry 104.

In some embodiments, the interface 103 may transport data packets using an interface protocol (e.g., PCIe protocol or NVMe protocol) to device 102. In some implementations, device 102 is a PCIe device that receives PCIe data packets via interface 103. In other implementations, device 102 is an NVMe device that receives NVMe data packets via interface 103. The interface 103 provides a network bus for signals (e.g., startup signal, first signal, or a confirmation signal), data, and instructions to be exchanged between the processing circuitry 104 and the controller 106. In some embodiments, the interface 103 may also be used for the controller 106 to read or write data from other components such as the persistent storage media 105 of device 102. When device 102 includes persistent storage media 105, persistent storage media may be used to store data associated with the operating states of the existing firmware prior to processing circuitry 104 changing or updating the existing firmware. In some embodiments, the data associated with the operating states of the existing firmware includes a firmware state, connectivity states to external devices via the interface 103 (e.g., PCIe interface or NVMe interface), and outstanding transactions to be executed by processing circuitry 104. Processing circuitry 104 may include a hardware processor, a software processor (e.g., a processor emulated using a virtual machine), or any combination thereof. Controller 106 may include any suitable software, hardware, or both for controlling interface 103, transmitting data to device 102, receiving data from device 102, and causing to update the firmware running on device 102. Controller 106 is communicatively coupled to the processing circuitry 104 to, for example, send one or more signals, data, or instructions, including a first signal (e.g., interrupt signal) which may initiate the bootloader trap firmware update. In some embodiments, controller 106 is communicatively coupled, via a respective interface (e.g., interface 103), to more than one device 102. Additionally, persistent storage media 105 may include hardware elements for non-transitory storage of commands or instructions, that, when executed by processing circuitry 104, cause processing circuitry 104 to operate in accordance with embodiments described herein.

While the present disclosure is described primarily in the context of, for example, device 102 (e.g., an SSD device) having processing circuitry 104, the features of the present disclosure can be applied to a device with distinct processors (whether uni-core, multi-core, or both). Therefore, device 102 may include multiple processors, wherein one or more processors are capable of updating firmware as described herein.

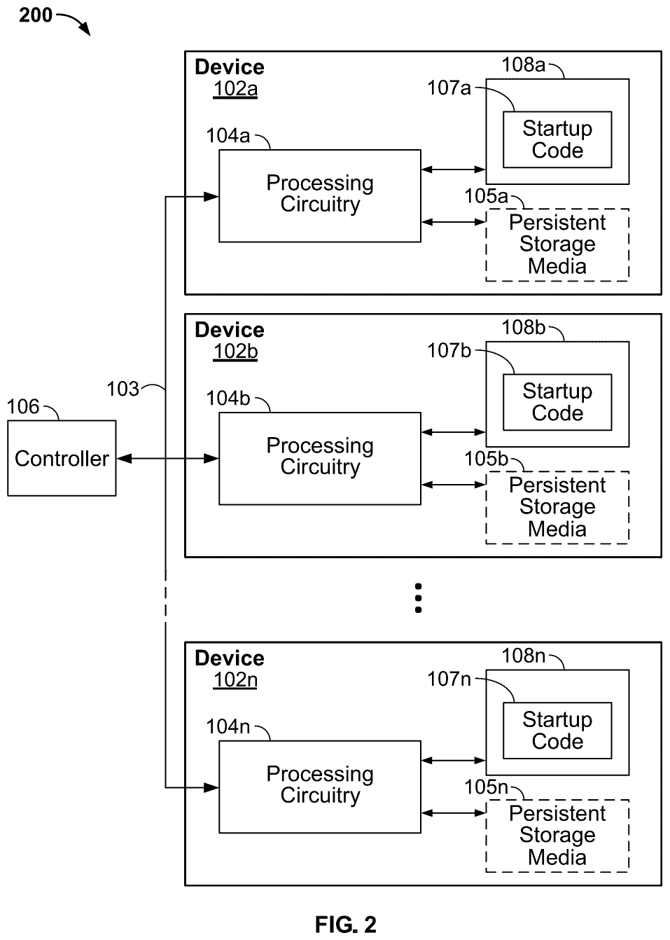

The controller 106 may be configured to send startup signals and signals (e.g., an interrupt signal) via interface 103 to the processing circuitry 104. The controller 106 is also configured to receive a confirmation signal from the processing circuitry 104 of the device 102 when the firmware has successfully been loaded to the device 102. In some embodiments, as shown in FIG. 2, controller 106 may be communicatively coupled to more than one device through interface 103. The controller 106 is configured to follow a transport protocol (e.g., PCIe or NVMe) that is compatible with interface 103 and each device (e.g., device 102) that is communicatively coupled to controller 106. Controller 106 is also configured to send data or instructions that are to be used or executed by processing circuitry 104 of device 102.

Solid state storage devices (for example, SSD devices) may include one or more packages of non-volatile memory dies, where each die includes storage cells. In some embodiments, the storage cells are organized into pages, and pages are organized into blocks. Each storage cell can store one or more bits of information. The solid-state storage device may further include a multi-core processor and storage controller. In some embodiments, Input/Output (I/O) commands from an external device, for example, write commands are buffered in a temporary storage (buffer) in the SSD storage device before being processed against memory or storage cells.

It will be understood that, while system 100 depicts an embodiment in which a device 102 communicatively coupled to interface 103 (e.g., PCIe interface or NVMe interface) is configured to have its firmware updated in accordance with the present disclosure, any other suitable device on another suitable interface can have its firmware updated in a similar manner. In some embodiments, other storage devices, peripheral devices, or other devices on interface 103 (e.g., PCIe interface or NVMe interface) may have their respective firmware updated.

For purposes of clarity and brevity, and not by way of limitation, the present disclosure is provided in the context of bootloader trap firmware updates that provide the features and functionalities disclosed herein. The bootloader trap firmware updates may be performed by any suitable software, hardware, or both for implementing such features and functionalities. The bootloader trap firmware updates can be at least partially implemented in, for example, system 100 (e.g., as part of device 102, or any other suitable device on which the firmware is being updated or changed). In some embodiments, bootloader trap firmware updates can be at least partially implemented in dedicated processing circuitry (e.g., processor or as one or more processor cores).

FIG. 2 shows an illustrative diagram of system 200 with multiple devices (e.g., first device 102a, second device 102b, and Nth device 102n) and controller 106, in accordance with some embodiments of the present disclosure. Although FIG. 2 shows three devices (e.g., first device 102a, second device 102b, and Nth device 102n), controller 106 may be communicatively coupled, via interface 103, to each of N devices. Each device (e.g., first device 102a, second device 102b, and Nth device 102n) is configured to perform bootloader trap firmware updates similarly as described above for device 102 in FIG. 1. Each device (e.g., first device 102a, second device 102b, and Nth device 102n) includes a respective processing circuitry (e.g., first processing circuitry 104a, second processing circuitry 104b, and Nth processing circuitry 104n), startup code (e.g., first startup code 107a, second startup code 107b, and Nth startup code 107n) stored on respective immutable storage memory (e.g., first immutable storage memory 108a, second immutable storage memory 108b, and Nth immutable storage memory 108n). In some embodiments, when each of one or more devices (e.g., first device 102a, second device 102b, and Nth device 102n) is an SSD device, each device of the one or more devices includes a respective persistent storage media (e.g., first persistent storage media 105a, second persistent storage media 105b, and Nth persistent storage media 105n). In embodiments of system 200, controller 106 is configured to transmit a startup signal to a subset of devices to initiate respective device startups for each of those devices, and transmit a first signal to each device of the subset of devices during their respective device startups. Once each respective processing circuitry of the subset of devices determines that a second signal has not been received by their respective device, the bootloader trap firmware update may be performed by the respective processing circuitry. In some embodiments, each device may be loaded with the same firmware or a respective firmware that is intended for a subset of devices, including one or more of the devices (e.g., first device 102a, second device 102b, and Nth device 102n).

In some embodiments, one or more devices may act as secondary devices to one or more primary devices. For example, first device 102a may act as a primary device that is communicatively coupled to and responsible for one or more secondary devices (e.g., second device 102b). In such an example, the secondary device (e.g., second device 102b) may be dependent on the performance of the firmware executing on the primary device (e.g., first device 102a). In some implementations, the primary device (e.g., first device 102a) and the secondary device (e.g., second device 102b) may use the same image of firmware (e.g., the same corrupted image of firmware). Therefore, when the primary device (e.g., first device 102a) performs the bootloader trap firmware update method disclosed herein, the firmware of the secondary device (e.g., second device 102b) may be updated and changed during the bootloader trap firmware update method. In some embodiments, when the firmware is received and loaded onto the primary device (e.g., first device 102a), the processing circuitry (e.g., first processing circuitry 104a) of primary device (e.g., first device 102a) may transmit or forward the received firmware directly to the secondary device (e.g., second device 102b) for the secondary device to perform the bootloader trap firmware update method. In some embodiments, the primary device may transmit the firmware to more than one secondary device. In some embodiments, each secondary device may be communicatively coupled to at least one tertiary device. In such embodiments, the secondary devices may be configured to perform the bootloader trap firmware updated method and forward the firmware to one or more tertiary device to perform the bootloader trap firmware update method with the forwarded firmware. This procedure may be implemented at any level or number of tiers within a hierarchy of devices (e.g., primary device, secondary device, tertiary device, etc.).

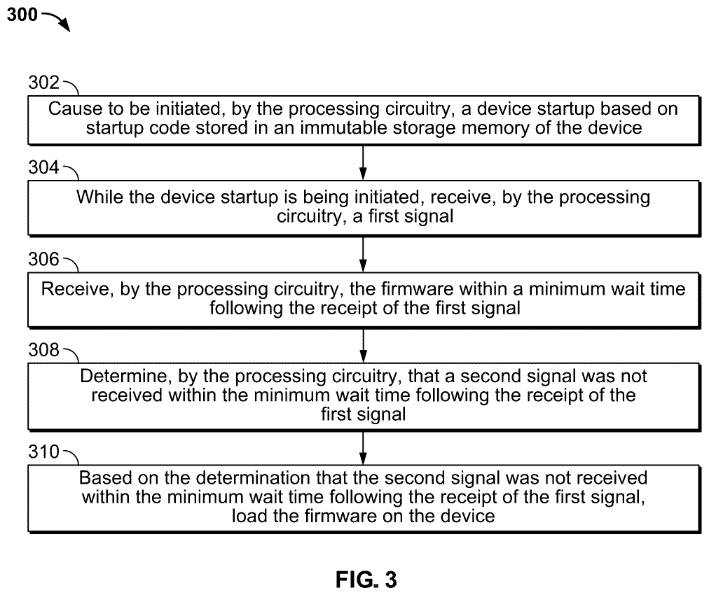

FIG. 3 shows a flowchart illustrating process 300 for loading firmware on a device, in accordance with some embodiments of the present disclosure. In some embodiments, the referenced device, interface, processing circuitry, immutable storage memory and startup code may be implemented as device 102, interface 103, processing circuitry 104, immutable storage memory 108, and startup code 107, respectively. In some embodiments, the process 300 can be modified by, for example, having steps rearranged, changed, added, and/or removed.

At step 302, the processing circuitry causes a device startup to be initiated based on the startup code stored in the immutable storage memory of the device. In some embodiments, the processing circuitry causes the device startup to be initiated once the processing circuitry receives a startup signal, i.e., from a controller communicatively coupled to the device. The startup signal may be a reset signal (e.g., a PERST signal), a power cycle signal, or any suitable signal that instructs or indicates to the processing circuitry that the device is to perform the device startup. In some embodiments, the processing circuitry has outstanding operations to execute when the startup signal is received from the controller. When the processing circuitry receives the startup signal, the execution of these outstanding operations is paused to initiate and perform the device startup based on the startup code stored in the immutable storage memory of the device. As previously discussed, the immutable storage memory may include any one or more of ROM, one or more one-time programmable fuses, a protected EEPROM, or WORM storage memory. In some embodiments, the startup code includes a routine or instructions for resetting or reinitializing the device. While the device startup is being initiated, the processing circuitry receives a first signal, at step 304.

At step 304, while the device startup is being initiated, the processing circuitry receives a first signal. In some embodiments, the first signal is an interrupt signal received by the processing circuitry on the interface (e.g., PCIe interface or NVMe interface) that communicatively couples the device to an external host device (e.g., a controller). During the device startup, the processing circuitry accesses the immutable storage memory to execute the device startup from the immutable storage memory based on the startup code. The immutable storage memory is configured to store data or instructions (e.g., startup code) that may not be overwritten or changed, and therefore provides a secure portion of memory that is protected from data corruption or manipulation of data or instructions stored on the device. While executing the startup code from the immutable storage memory, the processing circuitry receives the first signal. When the processing circuitry receives the first signal, the processing circuitry pauses the device startup and causes the device to be trapped as the processing circuitry is performing bootloader operations for the device startup. The processing circuitry then receives the firmware within a minimum wait time following the receipt of the first signal, at step 306.

At step 306, the processing circuitry receives the firmware within the minimum wait time following the receipt of the first signal. In some embodiments, the firmware is received from a controller that is communicatively coupled to the device. In other embodiments, the firmware is stored in memory that is accessible to processing circuitry, and therefore processing circuitry may request for the firmware to be sent to the device. In some embodiments, the firmware is one of a firmware image of firmware previously loaded on the device or an updated firmware. The processing circuitry then determines that a second signal was not received within a minimum wait time following the receipt of the first signal, at step 308.

At step 308, the processing circuitry determines that a second signal was not received within a minimum wait time following the receipt of the first signal. The minimum wait time following the receipt of the first signal may be a configurable value or based on a predetermined value. In some embodiments, the minimum wait time may be determined based on a worst-case delay and/or worst-case time between a first signal and a second signal received by the processing circuitry. In some embodiments, the minimum wait time elapses after the processing circuitry receives the first signal and the processing circuitry does not receive the second signal during the minimum wait time, and therefore the processing circuitry may determine that the first signal is used to trap the device while initiating or executing the device startup from the immutable storage memory of the device. In some other embodiments, the processing circuitry receives a second signal (e.g., from a controller) within the minimum wait time after the processing circuitry receives the first signal. In such embodiments, receiving the second signal indicates to the processing circuitry that the firmware of the device is not to be updated or changed, and instead, to perform operations based on the first signal, the second signal, and any other data or signals that are received thereon. Once the processing circuitry has determined that a second signal has not been received within the minimum wait time after the receipt of the first signal, the processing circuitry loads the firmware on the device, at step 310.

At step 310, based on the determination that the second signal was not received within the minimum wait time following the receipt of the first signal, the processing circuitry loads the firmware on the device. In some embodiments, the firmware that is to be loaded on the device is received from the controller. In such embodiments where the firmware is received by the processing circuitry from the controller, the processing circuitry may determine whether the received firmware is valid before loading the received firmware on the device. The firmware may have been previously stored in the persistent media of a storage device (e.g., an SSD device), to which the controller is communicatively coupled, or may be received from a database that the controller is communicatively coupled to through wireless communications. In some embodiments, the firmware is one of a firmware image of firmware previously loaded on the device or an updated firmware. The firmware that is to be loaded, by the processing circuitry, on the device may include an updated traffic manager, Input/Output porting of the processing circuitry and updates to the transport protocol (e.g., PCIe, NVMe, etc.) that corresponds to the interface that communicatively couples the device to the controller.

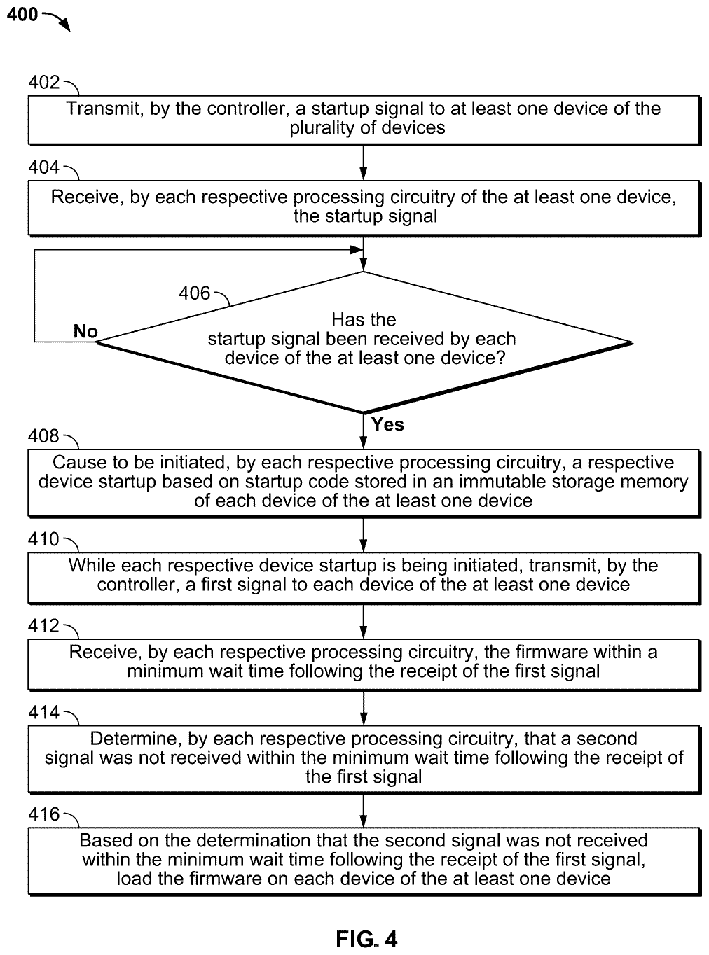

FIG. 4 shows a flowchart illustrating process 400 for loading firmware on one or more devices using a controller, in accordance with some embodiments of the present disclosure. In some embodiments, the referenced devices, interface, one or more processing circuitry, controller, one or more startup code, and one or more immutable storage memory may be implemented as N devices (e.g., first device 102a, second device 102b, and Nth device 102n), interface 103, one or more processing circuitry (e.g., first processing circuitry 104a, second processing circuitry 104b, and Nth processing circuitry 104n), controller 106, one or more startup code (e.g., first startup code 107a, second startup code 107b, and Nth startup code 107n), and one or more immutable storage memory (e.g., first immutable storage memory 108a, second immutable storage memory 108b, and Nth immutable storage memory 108n), respectively. In some embodiments, the process 400 can be modified by, for example, having steps rearranged, changed, added, and/or removed.

At step 402, the controller transmits a startup signal to at least one device of the plurality of devices. In some embodiments, the controller transmits a startup signal to each device that has outdated firmware or is a corrupted device (e.g., the firmware or stored data has been manipulated or corrupted). Once the controller transmits a startup signal to at least one device, each respective processing circuitry of at least one device receives the startup signal, at step 404.

At step 404, each respective processing circuitry of at least one device receives the startup signal. In some embodiments, when a respective processing circuitry of a device receives the startup signal, the respective processing circuitry causes the device to reset (e.g., hard reset or soft reset) before initiating the device startup from the respective immutable storage memory of the device based on the startup code stored on the respective immutable storage memory. The processing circuitry of each respective device of at least one device then determines whether the startup signal has been received from the controller, at step 406.

At step 406, each respective processing circuitry determines whether the startup signal has been received by each device. If the processing circuitry of a respective device determines that the startup signal has not been received by the respective device, the processing circuitry may continue to wait until the processing circuitry of the respective device has received the startup signal. When the processing circuitry of a respective device determines that the startup signal has been received by the respective device, the processing circuitry then causes a respective device startup to be initiated based on startup code stored in an immutable storage memory of the respective device, at step 408.

At step 408, each respective processing circuitry causes a respective device startup to be initiated based on startup code stored in the immutable storage memory of each device. Each respective processing circuitry causes the respective device startup to be initiated based on the respective processing circuitry receiving the startup signal from the controller. In some embodiments, each processing circuitry has outstanding operations to execute when the startup signal is received from the controller. For each respective device, when the processing circuitry receives the startup signal, the execution of these outstanding operations is paused to initiate and perform the device startup based on the startup code stored in the immutable storage memory of the respective device. As previously discussed, each immutable storage memory of the respective devices may include any one or more of ROM, one or more one-time programmable fuses, a protected EEPROM, or WORM storage memory. In some embodiments, the startup code stored in each immutable storage memory includes a routine or instructions for resetting or reinitializing the device using the device startup. While each respective device startup is being initiated, the controller transmits a first signal to at least one device (e.g., a subset of devices that received a startup signal at step 404), at step 410.

At step 410, while each respective device startup is being initiated, the controller transmits a first signal to each device. For each respective device that is performing a device startup, the processing circuitry receives a first signal. In some implementations the first signal is received within a maximum time limit after the startup signal is received by processing circuitry, at step 404. When the first signal is not received within a maximum time limit after the startup signal is received, the bootloader trap firmware update method may not be used. The maximum time limit may be a configurable value or based on a predetermined value. In some embodiments, the first signal is an interrupt signal received by the processing circuitry of each respective device on the interface (e.g., PCIe interface or NVMe interface). During the device startup, the processing circuitry of each respective device executes the device startup from the immutable storage memory of the respective device based on the startup code. Each immutable storage memory is configured to store data or instructions (e.g., startup code) that may not be overwritten or changed, and therefore provides a secure portion of memory that is protected from data corruption or manipulation of data or instructions stored on each respective device. While executing the device startup from the immutable storage memory of the respective device based on the startup code, the processing circuitry of the respective device receives the first signal. When the processing circuitry of the respective device receives the first signal, the processing circuitry pauses the device startup and causes the bootloader of the processing circuitry to be trapped as the processing circuitry is performing bootloader operations for the device startup. Each respective processing circuitry then receives the firmware within a minimum wait time following the receipt of the first signal, at step 412.

At step 412, each respective processing circuitry receives the firmware within the minimum wait time following the receipt of the first signal. In some embodiments, the firmware is received from a controller that is communicatively coupled to each respective device. In other embodiments, the firmware is stored in memory that is accessible to the respective processing circuitry, and therefore the respective processing circuitry may request for the firmware to be sent to the respective device. In some embodiments, the firmware is one of a firmware image of firmware previously loaded on the device or an updated firmware. Each respective processing circuitry then determines that a second signal has not been received within a minimum wait time following the receipt of the first signal, at step 414.

At step 414, each respective processing determines that a second signal was not received within the minimum wait time following the receipt of the first signal. The minimum wait time following the receipt of the first signal for each respective device may be a configurable value or based on a predetermined value. In some embodiments, the minimum wait time may be determined based on a worst-case delay and/or worst-case time between a first signal and a second signal received by the processing circuitry for each respective device. In some embodiments, the minimum wait time elapses after the processing circuitry for each respective device receives the first signal and the processing circuitry for each respective device does not receive the second signal during the minimum wait time. Therefore, the processing circuitry for each respective device may then determine that the first signal is used to trap the bootloader of the processing circuitry for each respective device while initiating or executing the device startup from the immutable storage memory of each respective device. In some other embodiments, the processing circuitry for each device of a subset of devices receives a second signal (e.g., from the controller) within the minimum wait time after the processing circuitry of each of the subset of devices receives the first signal. In such embodiments, receiving the second signal indicates to the processing circuitry of each device of the subset of devices that the firmware of the respective device is not to be updated or changed. Instead, the processing circuitry for each device of the subset of devices performs operations based on the first signal, the second signal, and any other data or signals that are received by the processing circuitry thereon. Once the processing circuitry of each respective device has determined that a second signal has not been received within the minimum wait time after the receipt of the first signal, the processing circuitry of each respective device loads the firmware on the respective device, at step 416.

At step 416, the processing circuitry loads the firmware on each respective device based on the determination that the second signal was not received within the minimum wait time following the receipt of the first signal. In some embodiments, the firmware that is to be loaded on each respective device is received from the controller. In such embodiments where the firmware is received by the processing circuitry of each respective device from the controller, the processing circuitry may determine whether the received firmware is valid before loading the received firmware on the respective device. In some embodiments, the firmware is one of a firmware image of firmware previously loaded on the respective device or an updated firmware. The firmware that is to be loaded by the processing circuitry on the respective device may include an updated traffic manager, Input/Output porting of the processing circuitry as well as updates to the transport protocol (e.g., PCIe, NVMe, etc.) that corresponds to the interface that communicatively couples the device to the controller.

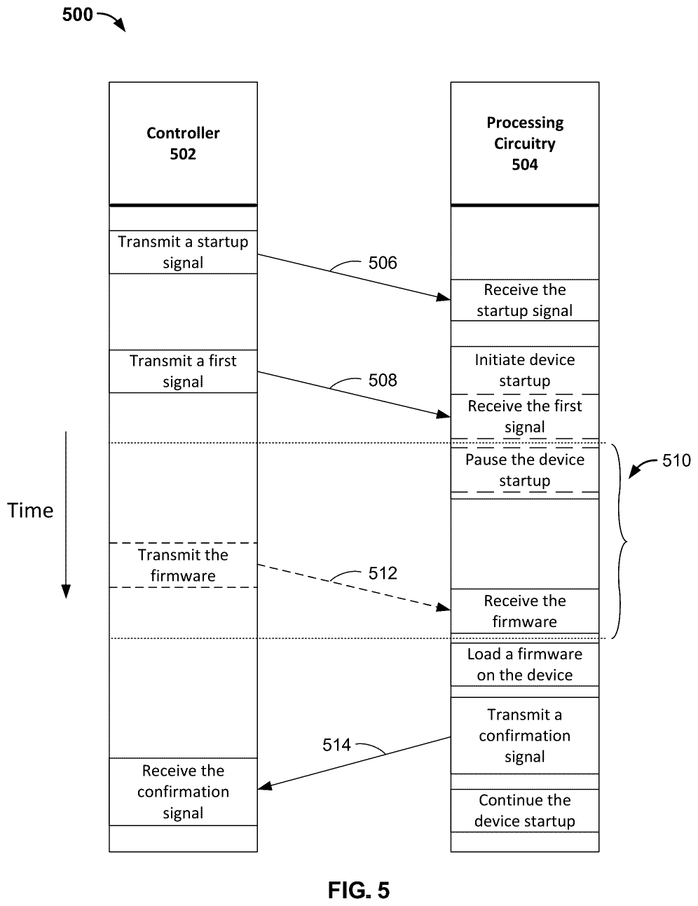

FIG. 5 shows a diagram illustrating chronological flow 500 between a controller 106 and processing circuitry 104 of a device 102 that concurrently execute programs or routines, in accordance with some embodiments of the present disclosure. Each timeline 502, 504 is represented by columns that follow a vertically sequential order for each of the controller 106 and processing circuitry 104, respectively, with a time variable indicator. The timelines indicate a relative parallelism between the execution stages of the controller 106 and the processing circuitry 104. Additionally, FIG. 5 shows the transmissions of data (e.g., signals or firmware) between the controller 106 and processing circuitry 104. Flow 500 shows a startup signal transmission 506 from the controller 106 to processing circuitry 104 to initiate a device startup. As discussed above, the startup signal may be a reset signal, power cycle signal, or any suitable signal that instructs or indicates to the processing circuitry that the device should perform the device startup. During the device startup, first signal transmission 508 is performed by controller 106 and received by processing circuitry 104. In some embodiments, the first signal is an interrupt signal, or any suitable signal received over an interface (e.g., PCIe interface or NVMe interface) from the controller 106. Once the processing circuitry 104 receives the first signal, the processing circuitry 104 pauses the device startup. In some embodiments, none of which are shown in flow 500, the processing circuitry 104 receives a second signal from the controller 106 within a minimum wait time 510 after the processing circuitry 104 receives the first signal. In such embodiments, this indicates to the processing circuitry 104 that the firmware of the device is not to be updated or changed, and instead, to perform operations based on the first signal, the second signal, and any other data or signals that are received thereon. In other embodiments, the minimum wait time 510 elapses after the processing circuitry 104 receives the first signal and the processing circuitry 104 does not receive the second signal during the minimum wait time 510, and therefore the processing circuitry may determine that the first signal is used to trap the device while initiating or executing the device startup from the immutable storage memory of the device. This ensures a more secure and efficient update or change in the firmware of the device. In some examples of the system disclosed herein, the controller 106 may perform a firmware transmission 512 to the processing circuitry 104 to provide the processing circuitry 104 with the firmware that is to be loaded onto the device. In some embodiments, the firmware that is to be loaded on the device is stored on the device or received from another external device (e.g., a second device that is communicatively coupled to the controller and the device). Once the processing circuitry 104 loads the firmware onto the device, i.e., updating or changing the existing firmware of the device, a confirmation signal transmission 514 may be performed by the processing circuitry 104 and received by controller 106. The confirmation signal of the confirmation signal transmission 514 may indicate to the controller 106 that the firmware has been successfully loaded on the device by processing circuitry 104.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A method for loading a firmware on a device comprising processing circuitry, the method comprising:
causing to be initiated, by the processing circuitry, a device startup based on startup code stored in an immutable storage memory of the device;
while the device startup is being initiated, receiving, by the processing circuitry, a first signal;
receiving, by the processing circuitry, the firmware within a minimum wait time following the receiving the first signal;
determining, by the processing circuitry, that a second signal was not received within the minimum wait time following the receiving the first signal; and
based on the determining that the second signal was not received within the minimum wait time following the receiving the first signal, loading the firmware on the device.

2. The method of claim 1, wherein the first signal is a first interrupt signal and the second signal is a second interrupt signal.

3. The method of claim 1, wherein the firmware is one of a firmware image of a firmware previously loaded on the device or an updated firmware.

4. The method of claim 1, wherein the immutable storage memory comprises any one or more of a read-only memory (ROM), one or more one-time programmable fuses, a protected electrically erasable programmable read-only memory (EEPROM), or a write-once-read-many (WORM) storage memory.

5. The method of claim 1, wherein receiving the firmware within the minimum wait time following the receiving the first signal comprises receiving the firmware from a controller within the minimum wait time following the receiving the first signal.

6. The method of claim 1, the method further comprising:
determining whether the received firmware is valid,
wherein the loading the firmware on the device based on the determining that the second signal was not received within the minimum wait time following the receiving the first signal comprises loading the firmware on the device based on the determining that the second signal was not received within the minimum wait time following the receiving the first signal and the determining that the received firmware is valid.

7. The method of claim 1, wherein the device is any one of a Peripheral Component Interconnect Express (PCIe) device or a Non-Volatile Memory Express (NVMe) device.

8. The method of claim 1, the method further comprising:
based on receiving the first signal, causing the device startup to be paused.

9. The method of claim 8, the method further comprising:
based on loading the firmware, causing the device startup to continue.

10. The method of claim 1, the method further comprising:
based on loading the firmware on the device:
generating, by the processing circuitry, a confirmation signal indicating that the firmware was loaded; and
transmitting the confirmation signal to a controller.

11. A device comprising:
immutable storage memory to store startup code; and
processing circuitry to:
cause a device startup to be initiated based on the startup code stored in the immutable storage memory;
while the device startup is being initiated, receive a first signal;
receive firmware within a minimum wait time after the first signal was received;
determine that a second signal was not received within the minimum wait time after the first signal was received; and
based on the determination that the second signal was not received within the minimum wait time after the receipt of first signal, load the firmware on the device.

12. The device of claim 11, wherein the first signal is a first interrupt signal and the second signal is a second interrupt signal.

13. The device of claim 11, wherein the firmware is one of a firmware image of a firmware previously loaded on the device or an updated firmware.

14. The device of claim 11, wherein the immutable storage memory comprises any one or more of a read-only memory (ROM), one or more one-time programmable fuses, a protected electrically erasable programmable read-only memory (EEPROM), or a write-once-read-many (WORM) storage memory.

15. The device of claim 11, wherein to receive firmware within the minimum wait time after the first signal was received the processing circuitry is to receive the firmware from a controller within the minimum wait time after the first signal was received.

16. The device of claim 11, wherein the processing circuitry is further to:
determine whether the received firmware is valid,
wherein to load the firmware on the device based on the determination that the second signal was not received within the minimum wait time after the receipt of the first signal the processing circuitry is to load the firmware on the device based on the determination that the second signal was not received within the minimum wait time after the receipt of the first signal and the determination that the received firmware is valid.

17. The device of claim 11, wherein the device is any one of a Peripheral Component Interconnect Express (PCIe) device or a Non-Volatile Memory Express (NVMe) device.

18. The device of claim 11, wherein the processing circuitry is further to:
based on receipt of the first signal, cause the device startup to be paused.

19. The device of claim 18, wherein the processing circuitry is further to:
based on the firmware being loaded, cause the device startup to continue.

20. The device of claim 11, wherein the processing circuitry is further to:
based on the firmware being loaded on the device:
generate a confirmation signal indicating that the firmware was loaded; and
transmit the confirmation signal to a controller.

21. A method for loading firmware on one or more devices of a plurality of devices using a controller, each respective device comprising respective processing circuitry, the method comprising:
transmitting, by the controller, a startup signal to at least one device of the plurality of devices;
receiving, by each respective processing circuitry of the at least one device, the startup signal;
in response to the receiving the startup signal, causing to be initiated, by each respective processing circuitry, a respective device startup based on startup code stored in an immutable storage memory of each device of the at least one device;
while each respective device startup is being initiated, transmitting, by the controller, a first signal to each device of the at least one device;
receiving, by each respective processing circuitry, the firmware within a minimum wait time following the receiving the first signal;
determining, by each respective processing circuitry, that a second signal was not received within the minimum wait time following the receiving the first signal; and
based on the determining that the second signal was not received within the minimum wait time following the receiving the first signal, loading a firmware on each device of the at least one device.

22. The method of claim 21, wherein the first signal is a first interrupt signal and the second signal is a second interrupt signal.

23. The method of claim 21, wherein the firmware is a first firmware of at least one firmware, and wherein loading the firmware on each device of the at least one device comprises loading the first firmware on each device of a first subset of devices of the at least one device, and loading a second firmware of the at least one firmware on each device of a second subset of devices of the at least one device.

24. The method of claim 21, wherein each immutable storage memory of each device of the at least one device comprises any one or more of a read-only memory (ROM), one or more one-time programmable fuses, a protected electrically erasable programmable read-only memory (EEPROM), or a write-once-read-many (WORM) storage memory.
